(19) United States
(12) Patent Application Publication
(10) Pub. No.: US 2019/0204982 A1
(43) Pub. Date: Jul. 4, 2019

(54) TOUCH CONTROL DEVICE, TOUCH CONTROL METHOD AND ELECTRONIC DEVICE

(71) Applicant: Lenovo (Beijing) Co., Ltd., Beijing (CN)

(72) Inventor: Shaopeng PENG, Beijing (CN)

(21) Appl. No.: 16/238,043

(22) Filed: Jan. 2, 2019

(30) Foreign Application Priority Data
Jan. 2, 2018 (CN) 201810003714.6

(51) Int. Cl. G06F 3/041; G06F 3/047; G06F 1/16

(52) U.S. Cl. CPC G06F 3/0416; G06F 1/1643; G06F 3/047

(57) ABSTRACT

A touch control device includes a sensing layer, a controller and a plurality of driving lines. The sensing layer includes a plurality of sensing units, which include a first type of sensing unit and a second type of sensing unit. The controller is coupled to the sensing layer and configured to determine a user touch on the sensing layer via the sensing units. The plurality of driving lines includes a first driving line coupled between the controller and the first type of sensing unit and a second driving line coupled between the controller and the second type of sensing unit. The controller is configured to provide a first driving signal to the first type of sensing unit via the first driving line and a second driving signal to the second type of sensing unit via the second driving line. The first driving signal is different from the second driving signal.

### CROSS-REFERENCE TO RELATED APPLICATION

This application claims the priority of Chinese Patent Application No. 201810003714.6, filed on Jan. 2, 2018, the entire contents of which are incorporated herein by reference.

### TECHNICAL FIELD

The present disclosure relates to a touch control device, a touch control method, and an electronic device

### BACKGROUND

For a display of an electronic device, the industry has been pursuing a high screen-to-body ratio, an improved ratio of a display area to the screen area, and a touch control sensing area to well match the display area. However, an electronic device such as an existing mobile phone needs to leave an image taking area for the camera on the surface where the display area is located. Therefore, a notch needs to be cut from a complete display with a regular shape (for example, a rectangle or square) to reveal the light sensing area for the camera. A size and shape of the notch are defined by the size and shape of the light sensing area for the camera. Regular display units that constitute the display have to be cut to form the notch and similarly, regular sensing units that constitute the control sensor have to be cut to form the notch.

In addition, due to the increasing industrial design requirements of the electronic device, at least the four corners of the screen need to match the corners of the electronic device. For example, the four corners of the phone are rounded corners, and the corners of the screen are mostly curved. The regular display units that constitute the display screen have to be cut to form the curved edges, and similarly, the regular sensing units that constitute the touch sensing have to be cut to form the curved edges.

In conventional technologies, the electronic device such as a mobile phone usually has certain functions enabled by an operation on the edge of the touch screen, for example, sliding down the upper edge to call the control center and the like.

### SUMMARY

In accordance with the disclosure, one aspect of the present disclosure provides a touch control device. The touch control device includes a sensing layer, a controller and a plurality of driving lines. The sensing layer includes a plurality of sensing units, which include a first type of sensing unit and a second type of sensing unit. The controller is coupled to the sensing layer and configured to determine a user touch on the sensing layer via the plurality of sensing units. The plurality of driving lines includes a first driving line and a second driving line. The first driving line is coupled between the controller and the first type of sensing unit. The second driving line is coupled between the controller and the second type of sensing unit. The controller is further configured to provide a first driving signal to the first type of sensing unit via the first driving line, and provide a second driving signal to the second type of sensing unit via the second driving line. The first driving signal is different from the second driving signal.

In accordance with the disclosure, another aspect of the present disclosure provides a touch control method. The touch control method includes providing a first driving signal to a first driving line that is coupled to a first type of sensing unit, providing a second driving signal to a second driving line that is coupled to a second type of sensing unit, and receiving the first driving signal from the first type of sensing unit and the second driving signal from the second type of sensing unit, to determine a user touch via the first and the second types of sensing units, respectively. The first driving signal is different from the second driving signal.

In accordance with the disclosure, another aspect of the present disclosure provides an electronic device. The device includes a touch display screen, a controller and a plurality of driving lines. The touch display screen includes a sensing layer. The sensing layer includes a plurality of sensing units, which include a first type of sensing unit and a second type of sensing unit. The controller is coupled to the sensing layer and configured to determine a user touch on the sensing layer via the plurality of sensing units. The plurality of driving lines includes a first driving line and a second driving line. The first driving line is coupled between the controller and the first type of sensing unit. The second driving line is coupled between the controller and the second type of sensing unit. The controller is further configured to provide a first driving signal to the first type of sensing unit via the first driving line, and provide a second driving signal to the second type of sensing unit via the second driving line. The first driving signal is different from the second driving signal.

### DESCRIPTION OF THE DRAWINGS

To clearly understand the present disclosure and advantages thereof, the present disclosure is described below with reference to the accompany drawings, in which:

FIGS. 1A-1B schematically illustrate a sensing layer that can be applied to a touch control device according to an embodiment of the present disclosure;

FIG. 2 is a block diagram of a touch control device according to an embodiment of the present disclosure;

FIG. 3A schematically illustrates a driving manner of a mutual-capacitance in a conventional technology;

FIG. 3B schematically illustrates a driving manner of a self-capacitance in a conventional technology;

FIG. 4 is a block diagram of a touch control device according to another embodiment of the present disclosure;

FIG. 5A schematically illustrates a diagram of a touch control effect of a touch control device according to an embodiment of the present disclosure;

FIG. 5B schematically illustrates a diagram of a touch control effect of a touch control device according to another embodiment of the present disclosure;

FIG. 5C schematically illustrates a diagram of a touch control effect of a touch control device according to another embodiment of the present disclosure;

FIG. 6 is a flow chart of a touch control method according to an embodiment of the present disclosure; and

FIG. 7 is a block diagram of an electronic device according to an embodiment of the present disclosure.

### DETAILED DESCRIPTION

Below describe embodiments of the present disclosure with reference to the accompanying drawings. It should be understood, however, that these descriptions are merely illustrative and are not intended to limit the scope of the present disclosure. In addition, in the following description, descriptions of well-known structures and techniques are omitted so as not to obscure the concept of the present disclosure.

Terms used herein are only for describing embodiments only but not intended to limit the present disclosure. The terms “including”, “comprising”, and the like, as used herein, indicate the presence of stated features, steps, operations, and/or components, but do not exclude the presence or addition of one or more other features, steps, operations, or components

Unless otherwise defined, all the technical and scientific terms used herein have the same or similar meanings as generally understood by those skilled in the art. It should be noted that terms used herein should be interpreted as having meanings that are consistent with the context of the present specification and should not be interpreted in an idealized or overly rigid manner.

In terms of a statement similar to “at least one of A, B, and C, etc.,” it should be generally interpreted in the light of the ordinary understanding of the expression by those skilled in the art (for example, “a system including at least one of A, B, and C” shall include, but is not limited to, a system including A alone, a system including B alone, a system including C alone, a system including A and B, a system including A and C, a system including B and C, and/or a system including A, B, and C, etc.). In terms of a statement similar to “at least one of A, B or C, etc.”, it should generally be interpreted in the light of the ordinary understanding of the expression by those skilled in the art (for example, “a system including at least one of A, B or C” shall include, but is not limited to, a system including A alone, a system including B alone, a system including C alone, a system including A and B, a system including A and C, a system including B and C, and/or a system including A, B, and C, etc.). It should also be understood by those skilled in the art that all transitional words and/or phrases representing two or more alternative items, whether in the description, the claims or the drawings, should be understood as including one of these alternative items, or including any one of or all these alternative items. For example, the phrase “A or B” should be interpreted to include possibilities of including “A” or “B”, or including “A” and “B”

Some block diagrams and/or flowcharts are shown in the drawings. It should be understood that some blocks and/or flows or combinations thereof in the block diagrams and/or the flowcharts can be implemented by computer program instructions. These computer program instructions may be provided to a processor of a general-purpose computer, a special-purpose computer, or other programmable-data processing device such that, when executed by the processor, these instructions may be configured to generate a device that can implement functions/operations illustrated in these block diagrams and/or flowcharts.

The techniques of the present disclosure may be implemented in the form of hardware and/or software (including firmware, microcode, etc.). In addition, the techniques of the present disclosure may in a form of a computer program product on a computer-readable medium that stores instructions. The computer program product can be used by or in connection with an instruction execution system. In the context of the present disclosure, a computer-readable medium may be any medium that can contain, store, communicate, propagate, or transport the instructions. For example, the computer-readable medium may include, but is not limited to, an electronic, magnetic, optical, electromagnetic, infrared or semiconductor system, apparatus, device, or propagation medium. Optionally, examples of the computer-readable medium include: a magnetic storage device such as a magnetic tape or a hard disk (HDD); an optical storage device such as a compact disk read-only memory (CD-ROM); a memory such as a random-access memory (RAM) or a flash memory; and/or a cable/wireless communication link.

The present disclosure includes the following terms. An integration of a touch panel and a display panel includes an In-Cell” method and an “On-Cell” method. The “In-Cell” method refers to a method of embedding a touch panel function into display pixels, while the “On-Cell” method refers to a method of embedding the touch panel function between a color filter substrate and a polarizing plate. Based on different driving methods, capacitive touch screens can be divided into self-capacitive touch screens and mutual-capacitive touch screens. For a self-capacitive touch screen, changes (with respect to the ground (GND)) of the self-capacitor of each sensing unit is detected. When a touch by a finger is detected, click arrays of both an X-axis and a Y-axis are detected respectively. Based on the capacitance changes of the self-capacitors before and after the touch, the X coordinate and Y coordinate of the finger can be determined and combined to obtain touch coordinates in a plane. While for a mutual-capacitive touch screen, a capacitance formed between two cross sensing blocks is detected and the two sensing blocks respectively forms two poles of the capacitor. The mutual capacitance detects the capacitance formed between the two cross sensing blocks, and the two sensing blocks respectively form the two poles of the capacitor. Using a mutual-capacitance measurement method, the lateral electrodes provide excitation signals, and all the electrodes in the longitudinal direction receive signals at the same time, so that the capacitance of all horizontal and vertical click junctions can be obtained, that is, the size of a two-dimensional plane of the entire touch screen.

Often irregular sensing units are sensing units of an irregular shape formed by cutting the regular sensing units constitute a curved portion of the edges of the electronic device. It may be difficult to sense a user operating on the curved portion of the edges of the electronic device, because of which, the user usually thinks the curved portion cannot be touch-sensed. Thus, the user tends to touch control using the non-curved portion by avoiding the curved portion to allow the electronic device to complete a certain operation. Therefore, the touch control experience is not complete, thereby decreasing an interaction efficiency between the user and the electronic device.

The electronic device disclosed in the present disclosure may leave a light sensing area for an camera on the surface where the display area is located. A notch is cut from a complete display (e.g., rectangular or square) of the electronic device to reveal the light sensing area of the camera. Among regular display units that constitute the display, at least part of the regular display units is cut to form the notch. Similarly, among regular sensing units that constitute touch control sensor, at least part of the regular sensing units is cut to form the notch. In addition, four edges and corners of the display of the electronic device needs to be consistent with four edges and corners of the electronic device, and the corners and edges of the display are usually curves. Among the regular display units that constitute the display, at least part of the regular display units is cut to form the curves. Similarly, among the regular sensing units that constitute touch control sensor, at least part of the regular sensing units is cut to form the curves.

One aspect of the present disclosure provides a touch control device including a sensing layer and a controller. The sensing layer includes a plurality of sensing units. The controller may be configured to control the sensing layer based on a plurality of driving lines, provide a first driving signal to a first driving line, and provide a second driving signal to a second driving line. The first driving signal is different from the second driving signal; sensing units corresponding to (e.g., passed by) the first driving line include at least one irregular sensing unit; and the at least one irregular sensing unit (corresponding to a first type of sensing unit) and regular sensing units (corresponding to a second type of sensing units) constitute the sensing layer.

It is a waste of resources that the irregular sensing units in conventional technologies are usually not used as a sensing unit. A technical solution according to embodiments of the present disclosure is providing the second driving signal to the irregular sensing units, where the first driving signal is different from the second driving signal. Using the technical solution, the irregular sensing units can be in an working state. In addition, the first driving signal is different from the second driving signal, and the first driving signal may be higher than the second driving signal. For example, the first driving signal may have higher voltage than the second driving signal. Therefore, the technical solution can also effectively solve a problem that: in the conventional technologies, even though a touch control chip provides a same driving signal to the irregular sensing units as the regular sensing units, there are not sufficient charges in the irregular sensing units and thereby a touch of a user finger (operating body) on the irregular sensing units cannot be sensed. Through the first driving line, the first driving signal can be sent to the irregular sensing units, to drive the irregular sensing units to work effectively. The irregular sensing units can sense the touch of the user finger (operating body), and effectively feed back a touch control signal to the touch control chip, such that the touch control chip can respond to a touch control operation (edge-touch control operation) based on the touch control signal fed back by the irregular sensing units. Therefore, the user can perform the touch control operation on any position of the edges, including the curved edges of the electronic devices.

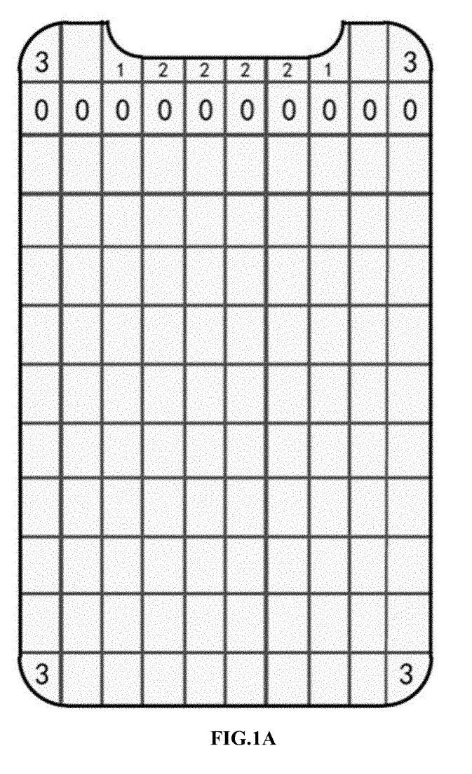

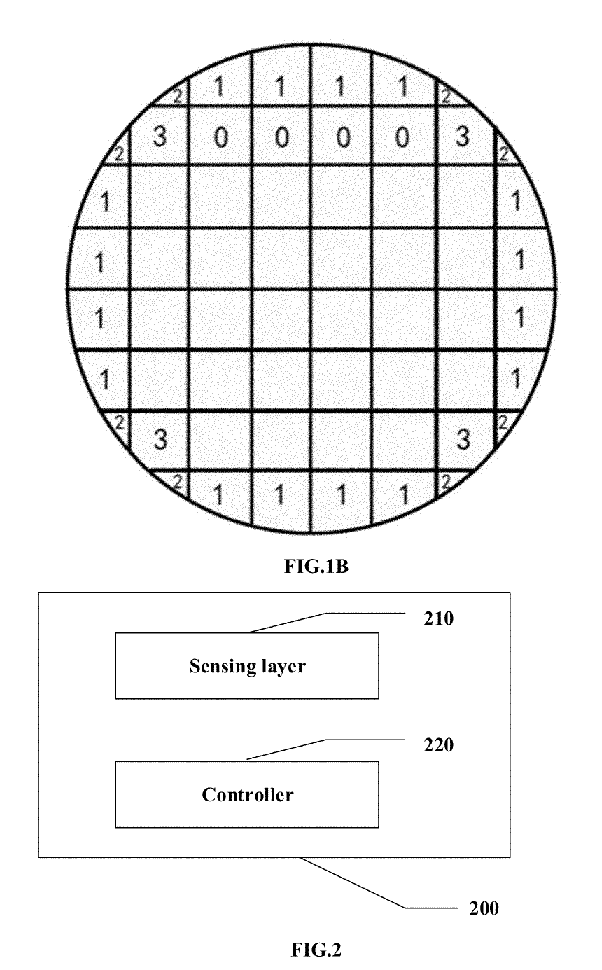

FIGS. 1A-1B schematically illustrate a sensing layer that can be applied to a touch control device according to an embodiment of the present disclosure.

According to an embodiment of the present disclosure, the touch control device may be applied to a touch screen system having a full screen shown in FIG. 1A. Because there is an earpiece or a camera at the center of the upper edge of the electronic device, FIG. 1A shows a touch screen with a notch. Further, the sensing layer may be composed of regular sensing units and irregular sensing units. Sensing units labeled as “0” are regular sensing units, which are rectangular, i.e. all rectangles in the touch screen are regular sensing units. Sensing units labeled as “1”, “2”, and “3” are irregular sensing units, and the irregular sensing units labeled as “1”, “2” and “3” have different areas. Driving signals corresponding to different areas of the irregular sensing units are different, which is further described in embodiments below. Optionally, the shape of the regular sensing units can be determined by a manufacturing process of the touch screen, and the shape may include a rectangle, a diamond, a hexagon, a triangle, a circle, and a snowflake, etc. Similarly, a size of the regular sensing units can be set according to the actual size and resolution of the display layer.

According to embodiments of the present disclosure, the touch control device may also be applied to a touch screen system having the circular screen shown in FIG. 1B. The sensing layer may be composed of regular sensing units (rectangular and labeled as “0”, and irregular sensing units (labeled as “1”, “2”, and “3”), and the irregular sensing units labeled as “1”, “2” and “3” have different area. Driving signals corresponding to different areas of the irregular sensing units are different, which is further described in embodiments below.

It should be noted that the shapes of the sensing layer shown in FIG. 1A and FIG. 1B are merely examples of a sensing layer of screens with different shapes, which is to help those skilled in the art to understand the technical content of the present disclosure, but not to limit the shape of the sensing layer. Embodiments of the present disclosure can also be applied for other variation and combination of screens with other shapes. A touch screen with any shape of which at least part of the edges (inner edge or/and outer edge) includes curves shall fall within the scope of the present disclosure.

It also should be noted that the number of rectangular sensing units shown in FIG. 1A and FIG. 1B is only an example of a plurality of sensing unit with different shapes, which is to help those skilled in the art understand the technical content of the present disclosure, but not to limit the shape and number of the sensing unit. The touch control device composed of other shapes and other number of the sensing units can also be obtained according to embodiments of the present disclosure, which is not elaborated herein.

FIG. 2 is a block diagram of a touch control device according to an embodiment of the present disclosure.

As shown in FIG. 2, a touch control device 200 may include a sensing layer 210 and a controller 220.

The sensing layer 210 may include a plurality of sensing units. Taking the sensing layer shown in FIG. 1 as an example, the sensing layer may be composed of a plurality of irregular sensing units (such as sensing units labeled as “1”, “2”, and “3”) and regular units (such as sensing units labeled as “0”).

The controller 220 is configured to control the sensing layer 210 based on the plurality of driving lines, provide a first driving signal to a first driving line, and provide a second driving signal to a second driving line.

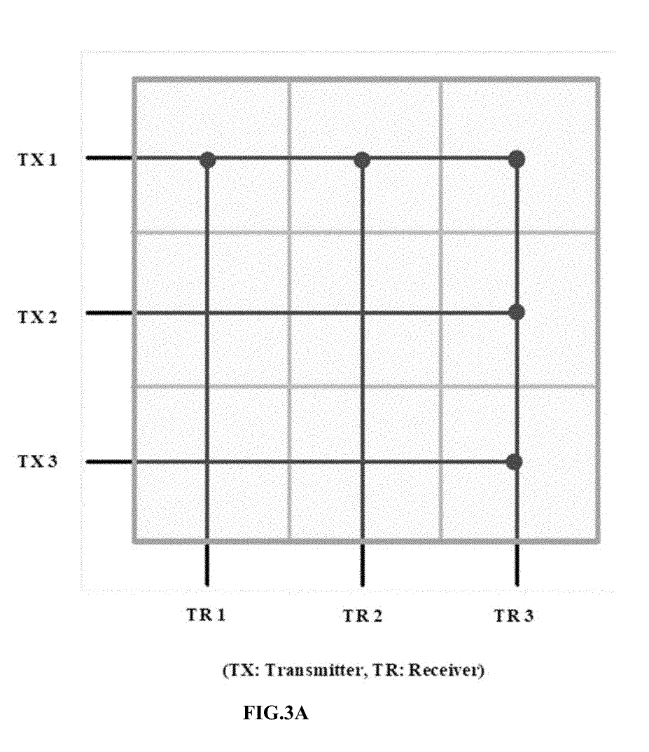

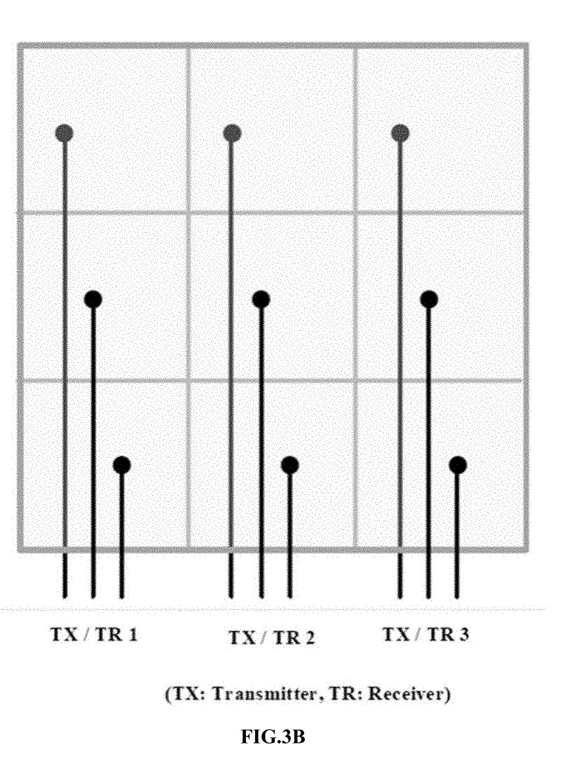

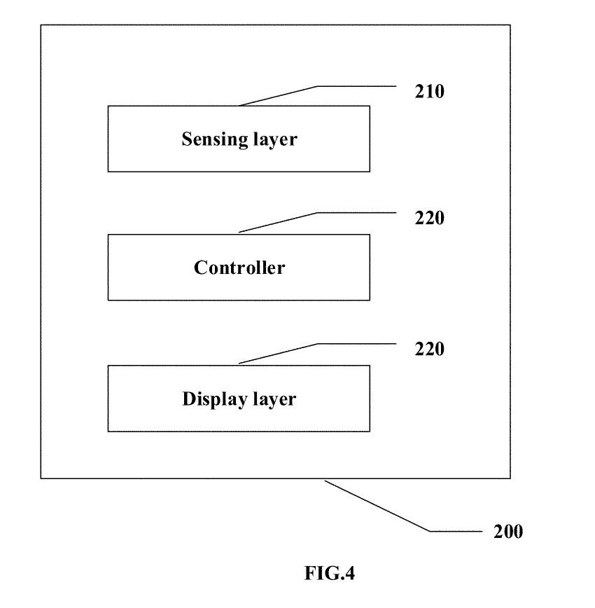

To realize the capacitive touch control, usually different tin indium oxide (ITO) conductive line modules are formed by etching the conductive coating layer of the ITO conductive glass. When supplied with electricity, a control layer may first supply driving voltage to channels formed by the conductive line modules, so as to form a specific electric field. Then based on a preset rule, for example, scanning column by column to detect a capacitance change between electrodes of the specific electric field, thereby achieving positioning of multiple spots. Referring to FIG. 3A and FIG. 3B, in the sensing layer, four rows are sequentially arranged in a lateral direction, and five columns are sequentially arranged in a longitudinal direction. It should be noted that the driving method is independent of the shape of the sensing layer.

The driving mode for the mutual-capacitor is shown in FIG. 3A. The X structure and Y structure are in different planes, a nod capacitance can be formed at an intersection of the X structure and the Y structure. Therefore, a capacitor can be formed by two cross sensing blocks, and the two sensing blocks may constitute the two poles of the capacitor. The channels sequentially distributed in the latitude direction can be used as n transmitters (TX 1, TX 2, . . . , TX N), corresponding to n driving lines sequentially passing through n rows of sensing units. The controller may send n driving signals to provide n driving voltages to the n driving lines. the channels sequentially distributed in the longitudinal direction can be used as m receivers (TR 1, TR 2, . . . , TR M) as detection lines to detect capacitance changes. The method that a drive line (axis) is driven by a set of voltage signals, and the response across the touch screen is detected by electrodes on other axes, is commonly referred to as “cross-over” sensing or transmissive sensing.

The driving mode of the self-capacitor is shown in FIG. 3B. The m channels sequentially distributed in the longitudinal direction can be used as m transmitters (TX 1, TX 2, . . . , TX M) on the one hand, and correspondingly correspond to m driving lines passing the m columns of sensing units. The controller may send m driving signals to provide m driving voltage to the m driving lines. The m channels sequentially distributed in the longitudinal direction can also be used as m receivers (TR 1, TR 2, . . . , TR M), which may be detection lines configured to detect the capacitance changes.

According to an embodiment of the present application, when the full screen of the touch control device as shown in FIG. 1A is driven by a mutual-capacitance method as shown in FIG. 3A, the touch control device may further include a first driving line and a second driving line.

The first driving line and the second driving line (horizontal driving lines shown in FIG. 3A) are both transmitters and connected to the touch control chip. The sensing units corresponding to (e.g., passed by) the first driving line include at least one irregular sensing unit. In other words, the sensing units corresponding to (e.g., passed by) the first driving line include multiple irregular sensing units and multiple regular sensing units; the sensing units corresponding to (e.g., passed by) the first driving line include one irregular sensing unit and multiple regular sensing units; the sensing units corresponding to (e.g., passed by) the first driving line include only one sensing unit and the one sensing unit is irregular sensing unit; and all the sensing units corresponding to (e.g., passed by) the first driving line are irregular sensing units and all the sensing units corresponding to (e.g., passed by) the second driving line are the regular sensing units.

According to an embodiment of the present application, when the full screen of the touch control device as shown in FIG. 1A is driven by a self-capacitance method as shown in FIG. 3B, the touch control device may further include a first driving line and a second driving line.

The first driving line and the second driving line are connected to the touch chip, and the first driving line and the second driving line can serve as both transmitters and receivers (the longitudinal driving lines shown in FIG. 3B). The longitudinal drive line is as shown in FIG. 3B. The sensing unit corresponding to (e.g., passed by) the first driving line has only one irregular sensing unit; the sensing unit corresponding to (e.g., passed by) the second driving line has only one regular sensing unit.

According to another embodiment of the present application, the touch screen can be applied to a circular screen as shown in FIG. 1B. In the circular screen, each of the irregular sensing units (labeled as “1”, “2”, and “3”) may need one driving line as the first driving line, and each of the regular sensing units may need one driving line as the second driving line.

According to an embodiment of the present disclosure, the first driving signal provided by the controller to the first driving line is different from the second driving signal provided to the second driving line. For example, if the driving signal is a signal of voltage, that the driving signal is different can be understood as that a voltage (level) of the first driving signal is higher than a voltage (level) of the second driving signal, or the voltage (level) of the first driving signal is lower than the voltage (level) of the second driving signal, which is not limited by the present disclosure and can be determined based on actual conditions.

According to embodiments of the present disclosure, among the plurality of driving lines, if the sensing units corresponding to (e.g., passed by) a driving line includes at least one irregular sensing unit, the driving line may provide a driving signal different from a driving signal of other driving lines. In this way, at least a part of the impact of the irregular sensing unit on the touch control performance can be reduced or canceled, thereby improving the user experience.

FIG. 4 is a block diagram of a touch control device according to another embodiment of the present disclosure.

As shown in FIG. 4, the touch control device 200 may further include a display layer 230.

According to an embodiment of the present disclosure, the display layer 230 may include a plurality of display units. Considering the manufacturing process, the display layer corresponds to (e.g., has a one-to-one correspondence with) the sensing layer. Therefore, the display units are composed by irregular display units corresponding to the irregular sensing units, and regular display units corresponding to the regular sensing units. In the present disclosure, an irregular display unit may refer to a display unit of an irregular shape in contrast to a regular shape, such as a square, rectangle, etc.

The display layer may be any screen for display in industry, such as a display layer composed by display units of red, green, and blue (RGB), which is not limited herein.

According to an embodiment of the present disclosure, according to the sensing units corresponding to (e.g., passed by) the first driving line include at least one irregular sensing unit, the first driving signal is different from the second driving signal.

It should be noted that the first driving signal can be configured to drive all the sensing units corresponding to (e.g., passed by) the first driving line. However, at least one irregular sensing unit is corresponding to (e.g., passed by) the first driving line, even if at least one regular sensing unit is corresponding to (e.g., passed by) the first driving line, the driving signal of the first driving line is determined based on the irregular sensing unit. Optionally, the first driving signal is configured to only drive the irregular sensing unit corresponding to (e.g., passed by) the first driving line, that is, only the irregular sensing unit be driven by the first driving signal. Whereas, the regular sensing units corresponding to (e.g., passed by) the first driving line may be driven by a third driving signal, that is, the third driving signal can be configured to only drive the regular sensing units corresponding to (e.g., passed by) the first driving line. Although sent through the same first driving line, the driving signal for driving the irregular sensing units is different from the driving signal for driving the regular sensing units, i.e. the first driving line is multiplexed.

It should be further noted that the first driving signal is determined based on an area of the at least one irregular sensing unit, an area of the at least one regular sensing unit, and a driving signal of the at least one regular sensing unit.

According to an embodiment of the present disclosure, the driving signal of an irregular sensing unit needs to be transmitted by the TX using a higher pulse driving voltage. The higher voltage can be determined by a ratio of the area of the irregular sensing unit to the area of the regular sensing unit. Optionally, the higher voltage may be inversely proportional to the area. For example, assuming the area of the regular sensing unit is 100% and a corresponding driving voltage of the TX is V1, when the area of the irregular sensing unit is only 50%, the driving voltage of the TX corresponding to the irregular sensing unit may be 2*V1. Similarly, the irregular sensing units with different areas correspond to different driving voltage. The smaller area the irregular sensing unit has, the higher driving voltage of the TX may be determined, such that the irregular sensing unit can be in an effective working state. Therefore, the irregular sensing units can sense the touch of the user finger (operating body), and effectively feed back a touch control signal to the touch control chip, such that the touch control chip can respond to a touch control operation (edge-touch control operation) based on the touch control signal fed back by the irregular sensing units. Therefore, the user can perform the touch control operation on any position of the edges, including the curved edges of the electronic devices. Alternatively, it can be understood that the driving signal of the irregular shaped sensing unit has a higher transmission power than the driving signal of the regular shaped sensing unit.

It should be noted that the foregoing method for determining the driving signal corresponding to the irregular sensing units is only exemplary and is not intended to limit to the present disclosure. Other methods may be selected according to actual conditions, and details are not described herein.

According to embodiments of the present disclosure, the first driving signal is determined based on an area of the at least one irregular sensing unit, an area of the at least one regular sensing unit, and a driving signal of the at least one regular sensing unit, which may at least partially reduce or cancel the effect on the touch screen caused by insufficient charges of the irregular sensing unit, thereby improving the user experience.

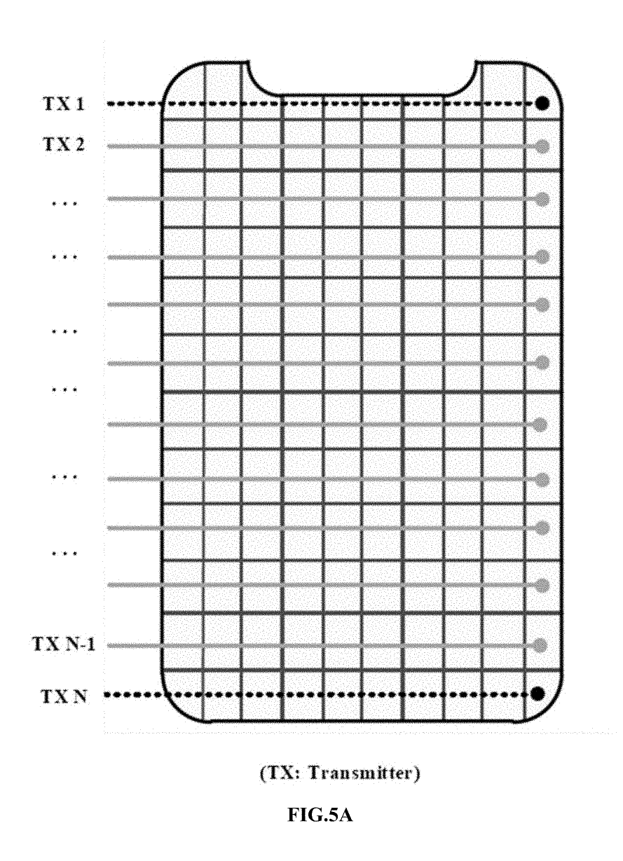

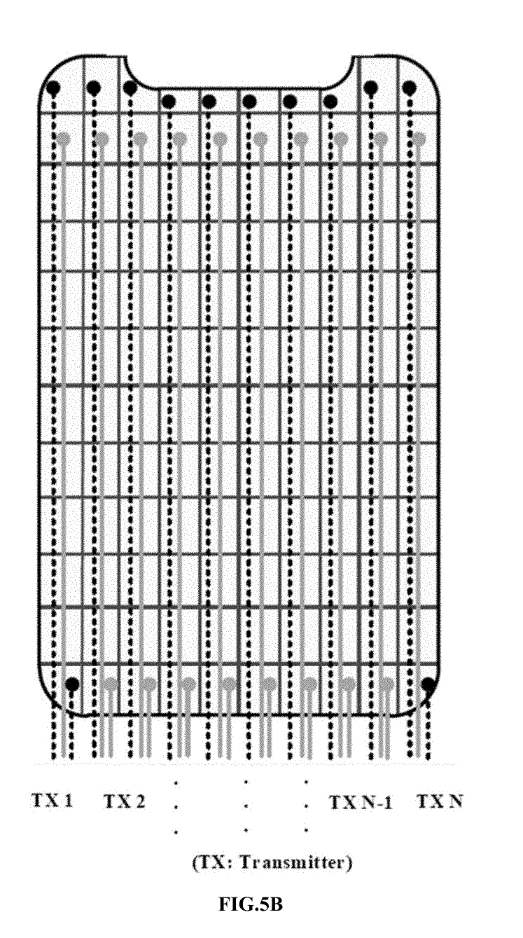

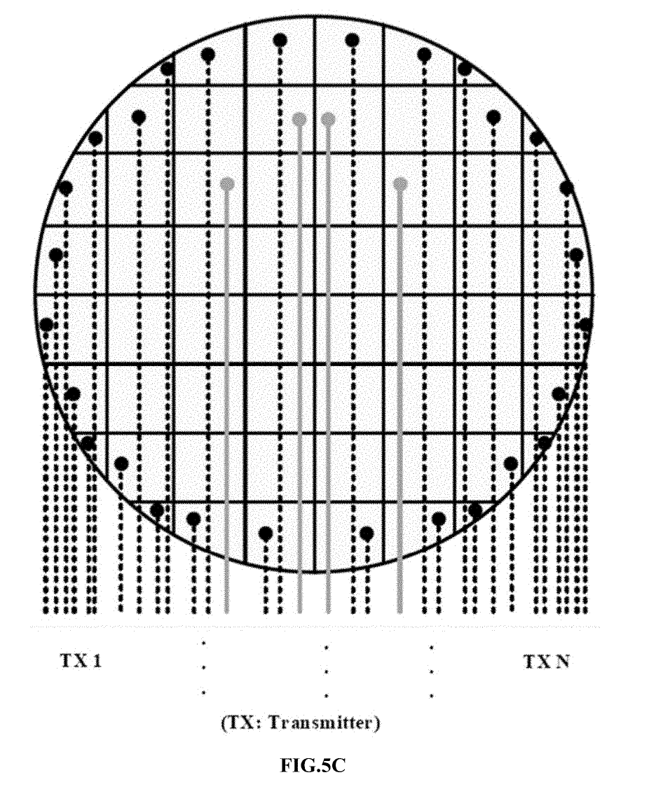

FIGS. 5A to 5C schematically illustrate diagrams of a touch control effect of a touch control device according to embodiments of the present disclosure.

It should be noted that the dashed lines shown in FIGS. 5A-5C represent the transmitter, corresponding to the driving lines by which the sensing units passed include at least one irregular sensing unit. The solid lines represent the driving lines for the regular sensing units.

FIG. 5A shows a diagram of the touch effect of the sensing layer in FIG. 1A driven by a driving mode of a mutual capacitive touch screen such as an external plug-in or an On-Cell.

The sensing units corresponding to (e.g., passed by) the 1st driving line and the Nth driving line (of driving lines 1, 2, 3, . . . , N) include at least one irregular sensing unit, and the 1st driving line and the Nth driving line are the first driving lines; the other driving lines are the second driving lines. Therefore, the TX 1 (e.g., corresponding to the 1st driving line) and the TX N (e.g., corresponding to the Nth driving line) drive corresponding sensing units with driving signals different from the other driving lines (e.g., driving lines 2, 3, . . . , N−1). The driving signals of the TX 1 and the TX N may be the same and may be the first driving signal, and the driving signals of TX 2, TX 3, . . . , TX N−1 may be the same and may be the second driving signal. The first driving signal is higher than the second driving signal. In some other embodiments, referring to FIG. 5A and FIG. 1A, the sensing units corresponding to (e.g., passed by) the 1st driving line include a plurality of irregular sensing units, which are marked with “1”, “2” and “3”. The irregular sensing units marked with “1”, “2” and “3” have different areas. According to embodiments of the present disclosure, among the irregular sensing units marked with “1”, “2” and “3”, the driving voltage corresponding to the irregular sensing unit that has the smallest area (e.g. the irregular sensing unit marked with “2”) may be used as the driving signal for the TX of the 1st driving lines, such that all the plurality of irregular sensing unit corresponding to (e.g., passed by) the first driving line can operate effectively. In this case, the 1st driving line and the Nth driving line are the first driving lines; the other driving lines are the second driving lines, the driving signal of TX 1 may be different from the driving signal of the TX N, and the driving signal of TX 1 may be higher than the driving signal of the TX N.

FIG. 5B is a diagram showing the touch effect of the sensing layer shown in FIG. 1A in a driving mode of e.g., an In-cell self-capacitive touch screen. Each of the plurality of irregular sensing units labeled as “1”, “2”, and “3” respectively corresponds to one of the plurality of first driving line. The driving signals of the TXs corresponding to the irregular sensing units labeled with “1”, “2” and “3” are different. Irregular sensing units having the same label have the same driving signal. The other driving lines that do not pass the irregular sensing units labeled with “1”, “2” and “3” are the second driving lines. The driving signals of the TXs corresponding to the second driving lines are the same as the second driving signal. The driving signal of any one of the irregular sensing units is higher than the driving signal of the regular sensing units.

FIG. 5C is a diagram showing the touch effect of the sensing layer shown in FIG. 1B in a driving mode of e.g., an In-cell self-capacitive touch screen. Each of the plurality of irregular sensing units labeled as “1”, “2”, and “3” respectively corresponds to one of the plurality of first driving line. The driving signals of the TXs corresponding to the irregular sensing units labeled with “1”, “2” and “3” are different. Irregular sensing units having the same label have the same driving signal. The other driving lines that do not pass the irregular sensing units labeled with “1”, “2” and “3” are the second driving lines. The driving signals of the TXs corresponding to the second driving lines are the same as the second driving signal. The driving signal of any one of the irregular sensing units is higher than the driving signal of the regular sensing units.

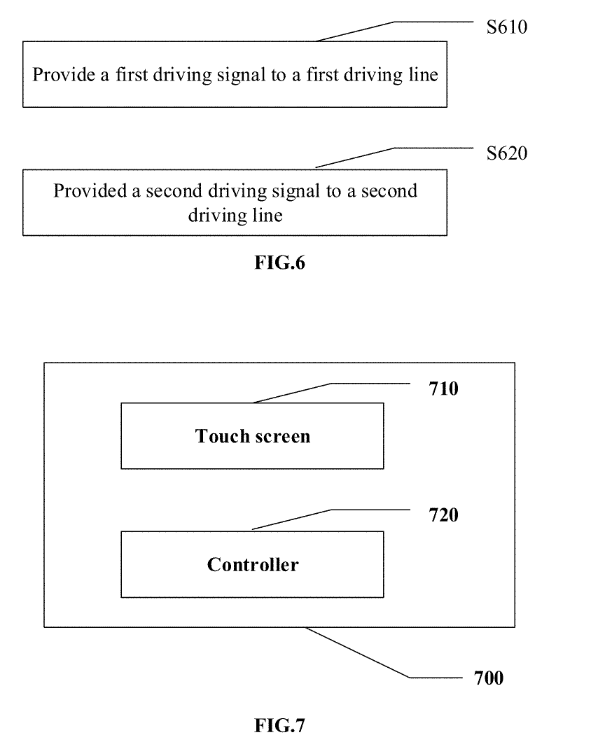

FIG. 6 is a flow chart of a touch control method according to an embodiment of the present disclosure.

As shown in FIG. 6, the touch control method may include operations S610 and S620.

In S610: A first driving signal is provided to a first driving line.

In S620: A second driving signal is provided to a second driving line.

According to an embodiment of the present disclosure, the first driving signal is different from the second driving signal, the sensing unit corresponding to (e.g., passed by) the first driving line includes at least one irregular sensing unit, and the irregular sensing units and the regular sensing units constitute the sensing layer.

According to embodiments of the present disclosure, among the plurality of driving lines, if the sensing units corresponding to (e.g., passed by) a driving line includes at least one irregular sensing unit, the driving line may provide a driving signal different from a driving signal of other driving lines. In this way, at least a part of the impact of the irregular sensing unit on the touch control performance can be reduced or canceled, thereby improving the user experience.

FIG. 7 is a block diagram of an electronic device according to an embodiment of the present disclosure.

As shown in FIG. 7, the electronic device 700 can include a touch screen 710 and a controller 720.

The touch screen 710 may include a display area, an edge of the display area includes at least one curve, and the display area includes a display layer composed of display units, a sensing layer composed of sensing units

The controller 720 may be configured to control the sensing layer based on a plurality of driving lines, provide a first driving signal to a first driving line, and provide a second driving signal to a second driving line. The first driving signal is different from the second driving signal; sensing units corresponding to (e.g., passed by) the first driving line include at least one irregular sensing unit; the at least one irregular sensing unit and regular sensing units constitute the sensing layer; the at least one irregular sensing unit corresponds to (e.g., has a one-to-one correspondence with) at least one irregular display unit; and the at least one irregular sensing unit and the at least one irregular display unit correspond to the at least one curve.

It should be noted that the edge of the display area including at least one curve may be an inner edge or an outer edge, such as a shape of a Chinese character “ [symbol] ”.

In addition to driving the sensing unit, the controller can also drive the display based on the display data line, which is not limited herein.

According to an embodiment of the present disclosure, all the sensing units corresponding to (e.g., passed by) the second driving line are regular sensing units.

For an irregular shaped touch screen, at least a part of the edges of the display (including inner edges and outer edges) includes curves. In the irregular shaped touch screen, the irregular display units of the display layer and the irregular sensing units of the sensing layer match the curves. According to embodiments of the present disclosure, because the irregular sensing units are different from the regular sensing units, the touch control chip may provide the first driving signal (voltage signal or level signal) to the irregular sensing units and provide the second driving signal to the regular sensing units. The first driving signal is different from the second driving signal. The first driving signal may be sent through the first driving line, and the first driving line may pass at least one irregular sensing unit. In this way, it can be ensured that when the user touches any position of at least a part of the curves of the edges, the user can have the same touch control experience as the user touches any other position of the touch screen.

Those skilled in the art should understand that the features described in embodiments and/or claims of the present disclosure can be combined in various manners, even though such combinations are not explicitly described in the present disclosure. In particular, various combinations of features described in various embodiments and/or claims of the present disclosure may be made without departing from the spirit and teaching of the present disclosure. All these combinations shall fall within the scope of the present disclosure.

Although the present disclosure has been shown and described with reference to specific exemplary embodiments thereof, it will be understood by those skilled in the art that without departing from the spirit and scope of the present disclosure defined by the appended claims and their equivalents, various modifications in form and detail may be made to the present disclosure. Therefore, the scope of the present disclosure should not be limited to the above-described embodiments but should be determined not only by the appended claims but also by the equivalents of the appended claims.

What is claimed is:

1. A touch control device, comprising:
a sensing layer including a plurality of sensing units comprising a first type of sensing unit and a second type of sensing unit;
a controller coupled to the sensing layer, the controller being configured to determine a user touch on the sensing layer via the sensing units; and
a plurality of driving lines including a first driving line coupled between the controller and the first type of sensing unit, and a second driving line coupled between the controller and the second type of sensing unit,
wherein:
the controller is further configured to provide a first driving signal to the first type of sensing unit via the first driving line, and a second driving signal to the second type of sensing unit via the second driving line, and the first driving signal is different from the second driving signal.

2. The touch control device according to claim 1, wherein the first driving signal has a higher transmission power than the second driving signal.

3. The device according to claim 1, further comprising:
a display layer including a plurality of display units; the plurality of display units including an irregular shaped display unit;
the irregular shaped sensing unit corresponding to an irregular shaped display unit.

4. The touch control device according to claim 1, wherein the first type of sensing unit is an irregular shaped sensing unit and the second type of sensing unit is a regular shaped sensing unit.

5. The device according to claim 4, wherein:
the sensing units corresponding to the second driving line are the regular shaped sensing units; and
the sensing units corresponding to the first driving line include multiple irregular shaped sensing units and multiple regular shaped sensing units.

6. The device according to claim 4, wherein:
the sensing units corresponding to the second driving line are the regular shaped sensing units; and
the sensing units corresponding to the first driving line include the irregular shaped sensing unit and multiple regular shaped sensing units.

7. The device according to claim 4, wherein:
the sensing units corresponding to the second driving line are the regular shaped sensing units.

8. The device according to claim 4, wherein:
the sensing units corresponding to the second driving line are the regular shaped sensing units; and
the sensing units corresponding to the first driving line are irregular shaped sensing units.

9. The device according to claim 4, wherein:
the sensing units corresponding to the first driving line include an irregular shaped sensing unit and a regular shaped unit.

10. The device according to claim 4, wherein:
the sensing units corresponding to the first driving line are all irregular shaped sensing units.

11. The device according to claim 4, wherein:
the first driving signal is configured to drive the sensing units corresponding to the first driving line.

12. The device according to claim 11, wherein:
the first driving signal is configured to drive the irregular shaped sensing unit among the sensing units corresponding to the first driving line.

13. The device according to claim 4, wherein:
the first driving signal is determined based on an area of the irregular shaped sensing unit, an area of the regular shaped sensing unit, and a driving signal of the regular shaped sensing unit.

14. A touch control method, comprising:
providing a first driving signal to a first driving line that is coupled to a first type of sensing unit;
providing a second driving signal to a second driving line that is coupled to a second type of sensing unit, wherein the second driving signal is different from the first driving signal; and
receiving the first driving signal from the first type of sensing unit and the second driving signal from the second type of sensing unit, to determine a user touch via the first and second types of sensing units, respectively.

15. The method according to claim 14, wherein the first type of sensing unit is an irregular shaped sensing unit and the second type of sensing unit is a regular shaped sensing unit.

16. The method according to claim 14, wherein the first driving signal has a higher transmission power than the second driving signal.

17. An electronic device, comprising:
a touch display screen, comprising a sensing layer including a plurality of sensing units, the plurality of sensing units including a first type of sensing unit and a second type of sensing unit, and
a controller coupled to the sensing layer, the controller being configured to determine a user touch on the sensing layer via the sensing units; and
a plurality of driving lines including a first driving line coupled between the controller and the first type of sensing unit, and a second driving line coupled between the controller and the second type of sensing unit,
wherein:
the controller is further configured to provide a first driving signal to the first type of sensing unit via the first driving line, and a second driving signal to the second type of sensing unit via the second driving line, and the first driving signal is different from the second driving signal.

18. The electronic device according to claim 17, wherein the first driving signal has a higher transmission power than the second driving signal.

19. The electronic device according to claim 17, wherein the first type of sensing unit is an irregular shaped sensing unit and the second type of sensing unit is a regular shaped sensing unit.

20. The electronic device according to claim 19, wherein:
the first driving signal is determined based on an area of the irregular shaped sensing unit, an area of the regular shaped sensing unit, and a driving signal of the regular shaped sensing unit.
